(19) United States
(12) Patent Application Publication
(10) Pub. No.: US 2010/0132518 A1
(43) Pub. Date: Jun. 3, 2010

(54) ADJUSTABLE SOCKET

(76) Inventor: Rui-He WANG, Hemei Township (TW)

Correspondence Address: PATENTTM.US, P. O. BOX 82788, PORTLAND, OR, 97282-0788, US

(21) Appl. No.: 12/622,451

(22) Filed: Nov. 20, 2009

(30) Foreign Application Priority Data
Dec. 1, 2008 (TW) 097146601

(51) Int. Cl. B25B 13/14

(52) U.S. Cl. 81/170; 81/179; 81/177.85

(57) ABSTRACT

An adjustable socket has a body, a connecting segment and an adjusting segment. The body has a proximal end, a distal end, a mounting hole, at least one adjusting recess and a through hole. The mounting hole is formed through the body. The at least adjusting recess is formed on the body. The connecting segment is mounted on the proximal end of the body. The adjusting segment is mounted on the distal end of the body and has a stationary clamp, an operating element and an adjusting clamp. The stationary clamp is formed on and protrudes from the body and has a guiding hole and two clamping faces. The operating element is rotatably mounted in the mounting hole and has a mounting rod and a worm wheel. The adjusting clamp is connected to and engages the operating element, faces the stationary clamp and has an engaging protrusion, multiple engaging teeth and two clamping faces.

### BACKGROUND OF THE INVENTION

1. Field of the Invention

The present invention relates to a sleeve, and more particularly to an adjustable socket that can be adjusted for fitting with screws and nuts of different sizes.

2. Description of Related Art

Conventional hand tools are convenient to use and have different kinds and types, socket wrenches are one kind of conventional hand tool and are used to rotatably adjust fasteners, such as screws or nuts. However, screws or nuts have different sizes, so different sized sockets are needed and interchanged for adjusting different fasteners, which is inconvenient and costly.

### SUMMARY OF THE INVENTION

The main objective of the present invention is to provide an adjusting socket that can be adjusted for adjusting different sized screws and nuts.

The adjusting socket in accordance with the present invention has a body, a connecting segment and an adjusting segment. The body has a proximal end, a distal end, a mounting hole, at least one adjusting recess and a through hole. The mounting hole is formed through the body. The at least adjusting recess is formed on the body. The connecting segment is mounted on the proximal end of the body. The adjusting segment is mounted on the distal end of the body and has a stationary clamp, an operating element and an adjusting clamp. The stationary clamp is formed on and protrudes from the body and has a guiding hole and two clamping faces. The operating element is rotatably mounted in the mounting hole and has a mounting rod and a worm wheel. The adjusting clamp is connected to and engages the operating element, faces the stationary clamp and has an engaging protrusion, multiple engaging teeth and two clamping faces.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a socket wrench with a first embodiment of an adjustable socket in accordance with the present invention;

FIG. 2 is a perspective view of the adjustable socket in FIG. 1;

FIG. 3 is a cross sectional side view of the adjustable socket in FIG. 2;

FIG. 4 is a partially exploded perspective view of a wrench with a second embodiment of an adjustable socket in accordance with the present invention;

FIG. 5 is an enlarged perspective view of the adjusting socket in FIG. 4;

FIG. 6 is a partially exploded perspective view of a third embodiment of a ratchet wrench with an adjustable socket in accordance with the present invention; and

FIG. 7 is a perspective view of the adjustable socket in FIG. 6.

### DETAILED DESCRIPTION OF THE PREFERRED EMBODIMENT

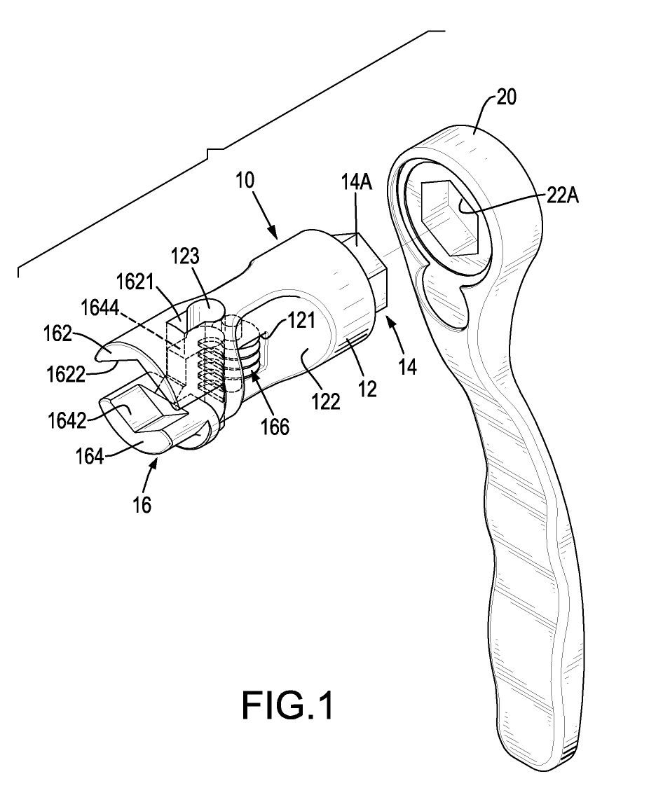

With reference to FIGS. 1, 4 and 6, an adjustable socket (10) in accordance with the present invention used on a wrench (20) having a mounting segment (22A, 22B, 22C) comprises a body (12), a connecting segment (14) and an adjusting segment (16). The mounting segment (22A, 22B, 22C) of the wrench (20) may be a hexangular hole (22A), a quadrilateral protrusion (22B) or a ratchet recess (22C) formed in/on one end of the wrench (20).

The body (12) may be cylindrical and has a distal end, a proximal end, an external surface, a mounting hole (121), at least one adjusting recess (122) and a through hole (123). The mounting hole (121) may be rectangular, is formed through the external surface of the body (12) and has an opening defined in the distal end of the body (12). The at least adjusting recess (122) is formed on the external surface of the body (12) between the proximal end and the distal end of the body (12). Perfectly, the body (12) has two adjusting recesses (122) symmetrically formed on the external surface of the body (12). The through hole (123) is formed through the distal end of the body (12) along a direction perpendicular to that of the mounting hole (121) and communicates with the opening of the mounting hole (121).

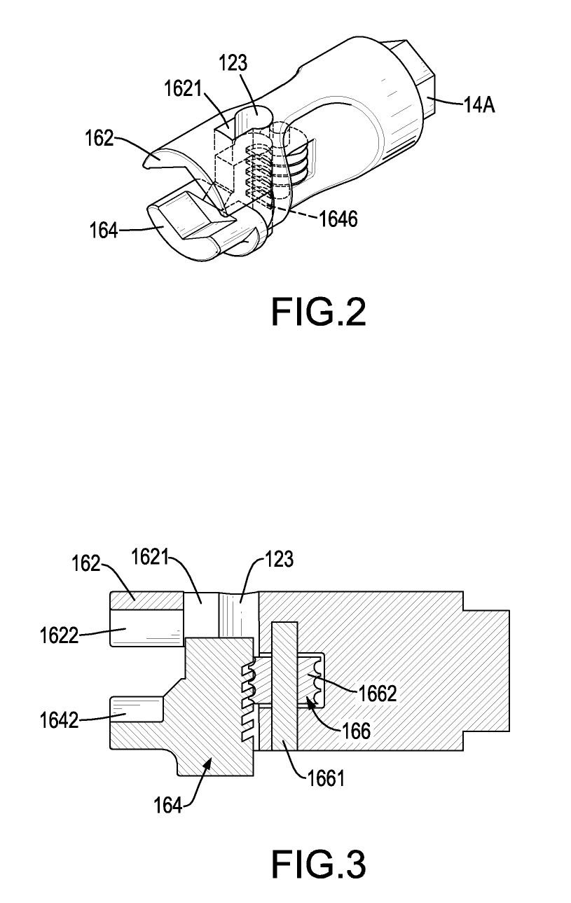

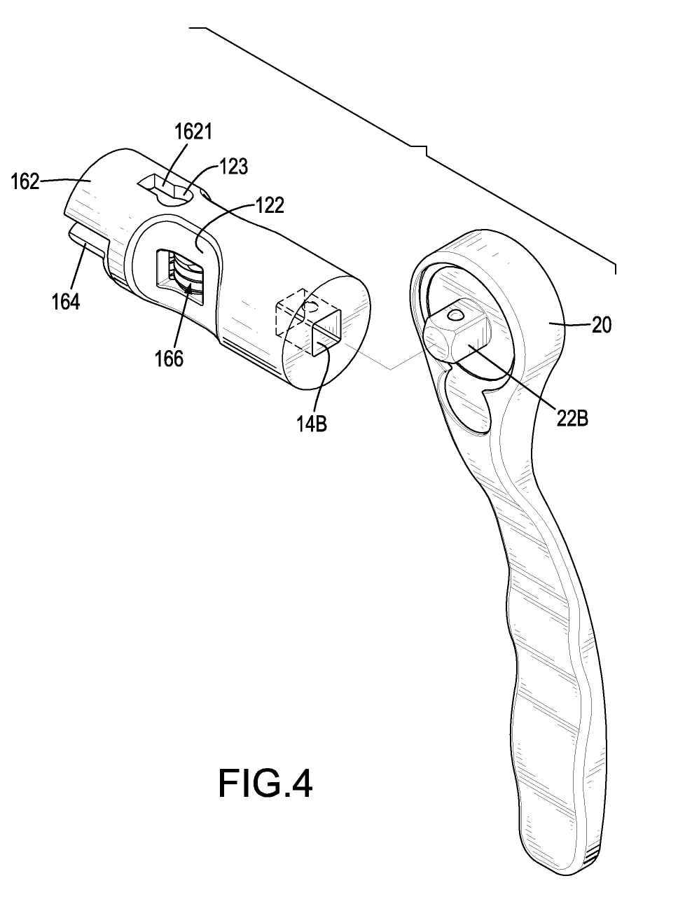

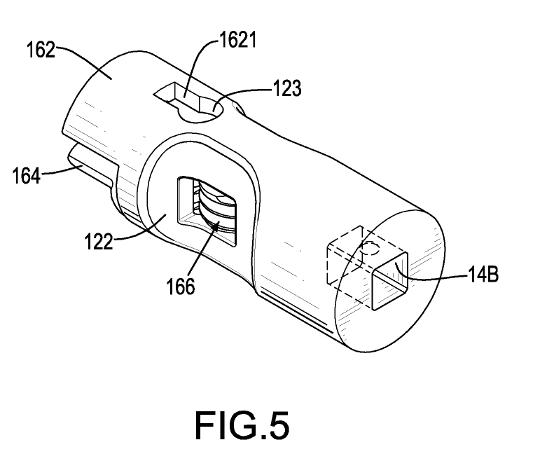

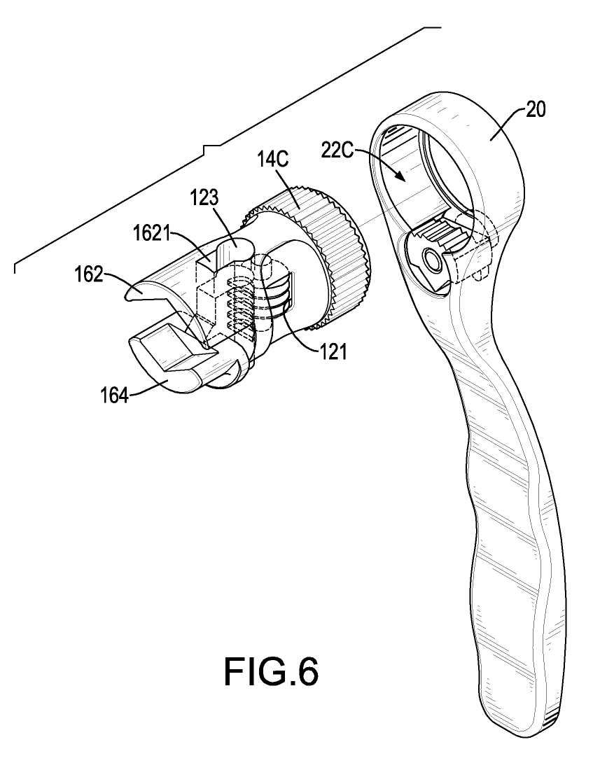

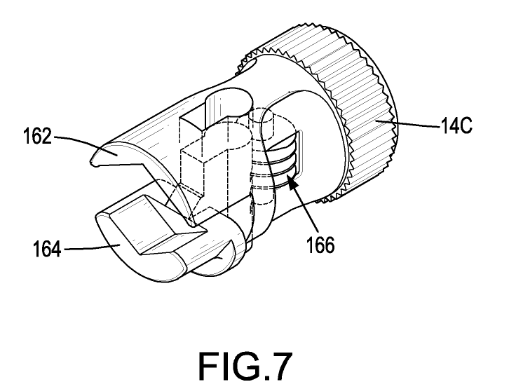

The connecting segment (14) is mounted on the proximal end of the body (12) to connect to the mounting segment (22A, 22B, 22C) of the wrench (20) and may be a hexangular protrusion (14A), an inserting hole (14B) or a ratchet wheel (14C). With reference to FIGS. 1 to 3, the hexangular protrusion (14A) is formed on and protrudes from the proximal end of the body (12) and is mounted in the hexangular hole (22A) of the wrench (22). With reference to FIGS. 4 and 5, the inserting hole (14B) may be quadrilateral, is formed in the proximal end of the body (12) and is mounted around the quadrilateral protrusion (22B) of the wrench (20). With reference to FIGS. 6 and 7, the ratchet wheel (14C) is formed on the proximal end of the body (12) and engages the ratchet recess (22C) of the wrench (20).

The adjusting segment (16) is mounted on the distal end of the body (12) and has a stationary clamp (162), an operating element (166) and an adjusting clamp (164).

The stationary clamp (162) is formed on and protrudes from the distal end of the body (12) and has a forming end, a free end, an internal surface, a guiding hole (1621) and two clamping faces (1622). The forming end of the stationary clamp (162) is formed on the distal end of the body (12). The guiding hole (1621) is formed through the forming end of the stationary clamp (162) and communicates with the through hole (123) of the body (12). The clamping faces (1622) are formed on the internal surface of the stationary clamp (162) near the free end to press against an external surface of a fastener, and have an angle formed between the clamping faces (1622).

With further reference to FIG. 3, the operating element (166) is rotatably mounted in the mounting hole (121) of the body (12) and has a mounting rod (1661) and a worm wheel (1662). The mounting rod (1661) is mounted in the mounting hole (121) of the body (12). The worm wheel (1662) is mounted rotatably around the mounting rod (1661) and extends partially into the through hole (123) of the body (12) via the opening of the mounting hole (121) of the body (12).

The adjusting clamp (164) is connected to and engages the operating element (166), faces to the stationary clamp (162) and has a connecting end, a free end, an internal surface, an engaging protrusion (1644), multiple engaging teeth (1646) and two clamping faces (1642). The engaging protrusion (1644) may be noncircular, is formed on and protrudes from the connecting end of the adjusting clamp (164), is mounted slidably in the through hole (123) of the body (12) and the guiding hole (1621) of the stationary clamp (162) and has an inner surface facing the worm wheel (1662) of the operating element (166). The engaging teeth (1646) are formed on the inner surface of the engaging protrusion (1644) and engage the worm wheel (1662) of the operating element (166). The clamping faces (1642) are formed on the internal surface of the adjusting clamp (164) near the free end and face the clamping faces (1622) of the stationary clamp (162) to press against the external surface of the fastener, and have an angle formed between the clamping faces (1642).

With reference to FIGS. 1, 4 and 6, when the adjustable socket (10) in accordance with the present invention is applied to adjust a fastener, the connecting segment (14), such as the hexangular protrusion (14A), the inserting hole (14B) or the ratchet wheel (14C) is connected to the hexangular hole (22A), the quadrilateral protrusion (22B) or the ratchet recess (22C) of the wrench (20) to connect the socket (10) with the wrench (20). The stationary clamp (162) and the adjusting clamp (164) of the adjusting segment (16) are mounted around and clamp an external surface of the fastener. By rotating the worm wheel (1662), the adjusting clamp (164) is moved relative to the stationary clamp (162) by engagement between the engaging teeth (1646) and the worm wheel (1662). Accordingly, the external surface of the fastener will be clamped by the clamping faces (1622, 1642) of the clamps (162, 164), and the fastener can be rotated by the wrench (20) via the socket (10). With the movement of the adjusting clamp (164), the distance between the clamping faces (1622, 1642) of the clamps (162, 164) can be adjusted to fit different fasteners. Furthermore, when adjusting, the at least one adjusting recess (122) that is formed on the external surface of the body (12) retains standard socket sizes so the adjustable socket (10) can be used in awkward places and orientations.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. An adjustable socket comprising:
a body having
a distal end;
a proximal end;
an external surface;
a mounting hole formed through the external surface of the body and having an opening defined in the distal end of the body;
at least one adjusting recess formed on the external surface of the body between the proximal end and the distal end of the body; and
a through hole formed through the distal end of the body along a direction perpendicular to that of the mounting hole and communicating with the opening of the mounting hole;
a connecting segment mounted on the proximal end of the body; and
an adjusting segment mounted on the distal end of the body and having
a stationary clamp formed on and protruding from the distal end of the body and having
a forming end formed on the distal end of the body;
a free end;
an internal surface;
a guiding hole formed through the forming end of the stationary clamp and communicating with the through hole of the body; and
two clamping faces formed on the internal surface of the stationary clamp near the free end and having an angle formed between the clamping faces;
an operating element rotatably mounted in the mounting hole of the body and having
a mounting rod mounted in the mounting hole of the body; and
a worm wheel mounted rotatably around the mounting rod and extending partially into the through hole of the body via the opening of the mounting hole of the body; and
an adjusting clamp connected to and engaging the operating element, facing the stationary clamp and having
a connecting end;
a free end;
an internal surface;
an engaging protrusion formed on and protruding from the connecting end of the adjusting clamp, mounted slidably in the through hole of the body and the guiding hole of the stationary clamp and having an inner surface faced the worm wheel of the operating element;
multiple engaging teeth formed on the inner surface of the engaging protrusion and engaging the worm wheel of the operating element; and
two clamping faces formed on the internal surface of the adjusting clamp near the free end, facing the clamping faces of the stationary clamp and having an angle formed between the clamping faces.

2. The adjustable socket as claimed in claim 1, wherein the body has two adjusting recesses symmetrically formed on the external surface of the body.

3. The adjustable socket screwdriver as claimed in claim 2, wherein the engaging protrusion of the adjusting clamp is noncircular.

4. The adjustable socket screwdriver as claimed in claim 3, wherein the connecting segment is a hexangular protrusion and is formed on and protrudes from the proximal end of the body.

5. The adjustable socket screwdriver as claimed in claim 3, wherein the connecting segment is an inserting hole and is formed in the proximal end of the body.

6. The adjustable socket screwdriver as claimed in claim 3, wherein the connecting segment is a ratchet wheel and is formed on the proximal end of the body.

7. The adjustable socket screwdriver as claimed in claim 1, wherein the engaging protrusion of the adjusting clamp is noncircular.

8. The adjustable socket screwdriver as claimed in claim 1, wherein the connecting segment is a hexangular protrusion and is formed on and protrudes from the proximal end of the body.

9. The adjustable socket screwdriver as claimed in claim 1, wherein the connecting segment is an inserting hole and is formed in the proximal end of the body.

10. The adjustable socket screwdriver as claimed in claim 1, wherein the connecting segment is a ratchet wheel and is formed on the proximal end of the body.

11. The adjustable socket screwdriver as claimed in claim 2, wherein the connecting segment is a hexangular protrusion and is formed on and protrudes from the proximal end of the body.

12. The adjustable socket screwdriver as claimed in claim 2, wherein the connecting segment is an inserting hole and is formed in the proximal end of the body.

13. The adjustable socket screwdriver as claimed in claim 2, wherein the connecting segment is a ratchet wheel and is formed on the proximal end of the body.
